(19) United States
(12) Patent Application Publication
(10) Pub. No.: US 2006/0132508 A1
(43) Pub. Date: Jun. 22, 2006

(54) Multi-planar image viewing system and method

(76) Inventor: Navid Sadikali, Kitchener (CA)

Correspondence Address: BERESKIN AND PARR, 40 KING STREET WEST, BOX 401, TORONTO, ON, M5H 3Y2, CA

(21) Appl. No.: 11/012,180

(22) Filed: Dec. 16, 2004

(51) Int. Cl. G09G 5/00

(52) U.S. Cl. 345/665

(57) ABSTRACT

A multi-planar image viewing system for displaying first and second selectable indicia on a display for application to a launching series having an initial planar orientation. The system comprises a series launching module, a viewing tool generation module and a viewing tool module. The launching module stores the initial planar orientation associated with the launching series. The viewing tool module determines a first viewing format and a second viewing format for the launching series based on the initial planar orientation of the launching series. The viewing tool module also displays the first selectable indicia that corresponds to the first viewing format and the second selectable indicia that corresponds to the second viewing format on the display. The view generation module generates and displays the launching series in the initial planar orientation and the first and second selectable indicia on the display.

### FIELD OF THE INVENTION

This invention relates to an image viewing system and method and more particularly to a system and method for generating and displaying multi-planar images on a contextual basis.

### BACKGROUND OF THE INVENTION

Commercially available image viewing systems in the medical field utilize various techniques to present visual representations of image data to a user. Specifically, image data produced within modalities such as Computed Tomography (CT) and the like is displayed on a display terminal for review by a medical practitioner at a medical treatment site. In order for a medical practitioner to properly analyze image data in three dimensions, image data is typically presented in various multi-planar views each having a particular planar orientation.

FIG. 1A illustrates the conventionally known standard anatomical position that is utilized to provide uniformity to modality images. The standard anatomical position is where the subject is standing, feet together pointing forward, palms forward (no bones crossed), arms at sides, looking forward. As is conventionally, known, no matter what position a bone or skeleton is found in, surfaces are referred to as if the subject is standing erect in this standard anatomical position.

The various planes of reference are defined within this standard anatomical position, namely sagittal (FIG. 1B), coronal (FIG. 1C), transverse (or axial) (FIG. 1D) and oblique (FIG. 1E). As shown in FIG. 1B, the sagittal reference plane divides the subject into right and left halves. FIG. 1C illustrates the coronal plane or the frontal plane. As shown, the coronal reference plane divides the subject into anterior and posterior halves and is oriented at right angles to the sagittal reference plane. FIG. 1D illustrates the traverse reference plane or the axial reference plane. As shown, the transverse reference plane has a horizontal planar orientation and slices through the subject at any height. Generally speaking the transverse reference plane is perpendicular or orthogonal to the sagittal (FIG. 1B) and coronal (FIG. 1C) reference planes. It should be understood that in the case of an organ or other structure, a transverse reference plane is at right angles to the long axis of the organ or structure. Finally, FIG. 1E illustrates an oblique reference plane. As shown, the oblique reference plane may lie at any angle in respect of the subject.

By comparing various multi-planar views of an image series, a medical practitioner can better determine the presence or absence of a medical condition (e.g. disease, tissue damage etc.) Many attempts to optimize the display and presentation of multi-planar image data for viewing by a medical practitioner have been made. Currently, when a medical professional wishes to review different views of medical image data on a computer system, it is necessary for the medical professional to provide a number of distinct instructing commands. The provision of such instructing commands can be inconvenient and time consuming.

### SUMMARY OF THE INVENTION

The invention provides in one aspect, a multi-planar image viewing system for displaying first and second selectable indicia on a display for application to a launching series having an initial planar orientation, said system comprising:
(a) a memory for storing the launching series and the initial planar orientation associated with the launching series;
(b) a processor coupled to the memory for:
   (I) determining a first viewing format and a second viewing format for the launching series based on the initial planar orientation of the launching series; and
   (II) displaying the first selectable indicia that corresponds to the first viewing format and the second selectable indicia that corresponds to the second viewing format on the display.

The invention provides in another aspect a method for displaying first and second selectable indicia on a display for application to a launching series having an initial planar orientation, said method comprising:
(a) storing the launching series and the initial planar orientation associated with the launching series;
(b) determining a first viewing format and a second viewing format for the launching series based on the initial planar orientation of the launching series; and
(c) displaying the first selectable indicia that corresponds to the first viewing format and the second selectable indicia that corresponds to the second viewing format on the display.

Further aspects and advantages of the invention will appear from the following description taken together with the accompanying drawings.

### BRIEF DESCRIPTION OF THE DRAWINGS

For a better understanding of the present invention, and to show more clearly how it may be carried into effect, reference will now be made, by way of example, to the accompanying drawings which show some examples of the present invention, and in which:

FIGS. 1A, 1B, 1C, 1D, and 1E are all drawings illustrating the planar orientation of the sagittal, coronal, transverse (axial) and oblique reference planes within a human subject;

FIG. 2 is a block diagram of the multi-planar image viewing system of the present invention;

FIG. 3A is a schematic diagram of the contextual viewing tool interface provided by the viewing tool module of FIG. 2;

FIGS. 3B to 3G are schematic diagrams illustrating the multi-planar display of an image series;

FIG. 4 is a flowchart diagram of the main process steps executed by the multi-planar image viewing system of FIG. 2;

FIG. 5A is a flowchart diagram of an example set of process steps executed by the viewing tool module of FIG. 2;

FIGS. 5B, 5C and 5D are schematic diagrams illustrating the view generation indicia that are generated for display on the viewing tool interface by the viewing tool module of FIG. 2;

FIG. 6A is a flowchart diagram of another example set of process steps executed by the viewing tool module of FIG. 2;

FIGS. 6B, 6C and 6D are schematic diagrams illustrating the view generation indicia that are generated for display on the viewing tool interface by the viewing tool module of FIG. 2; and

FIG. 7 is a flowchart diagram of the process steps executed by the view generation module of FIG. 2.

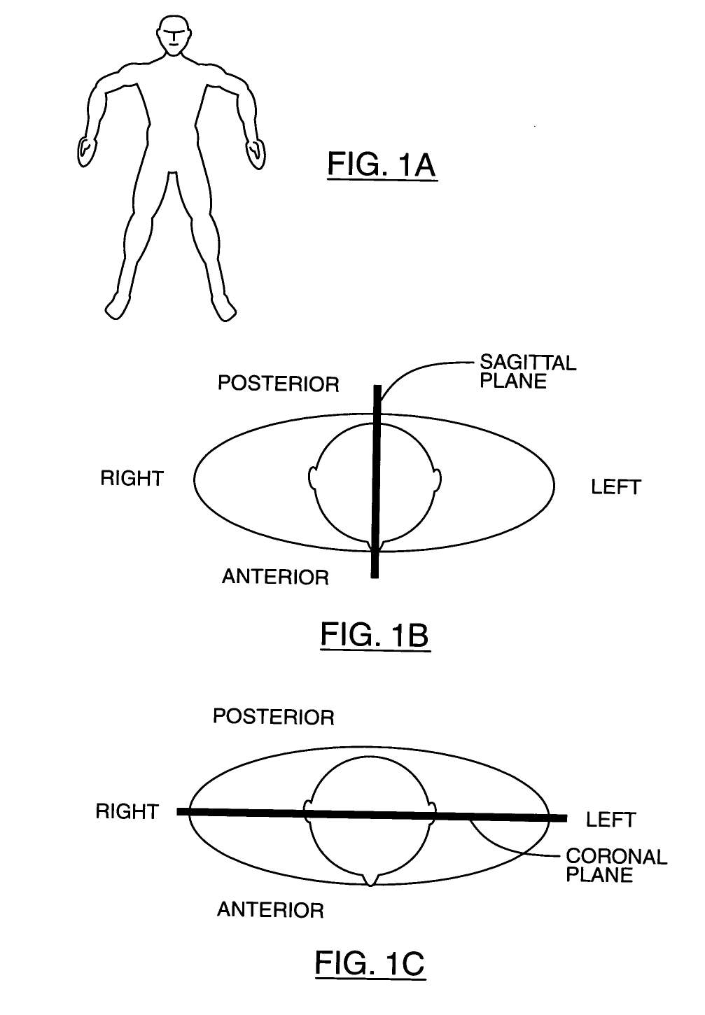

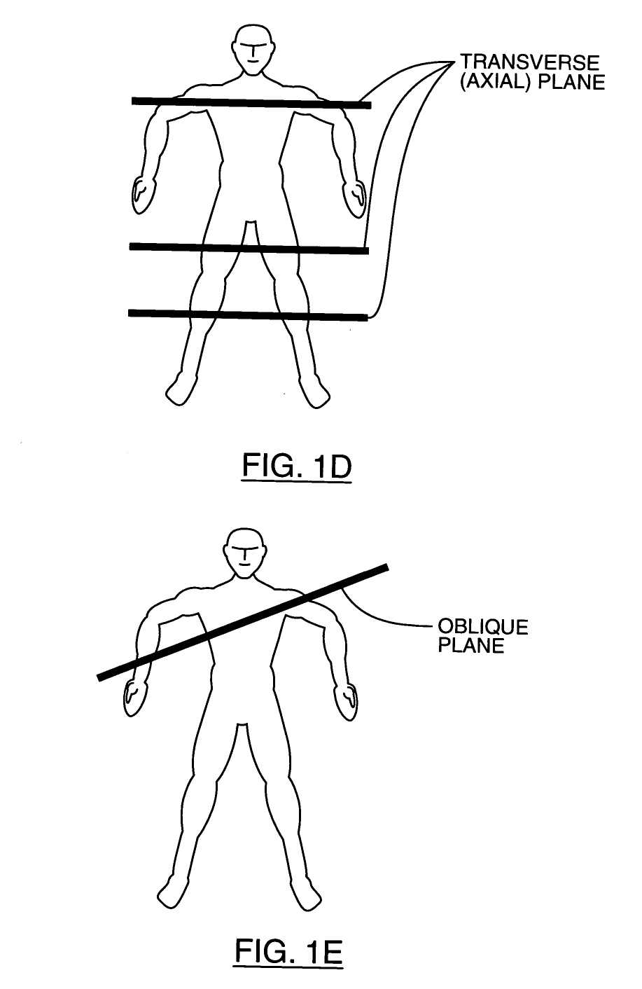

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

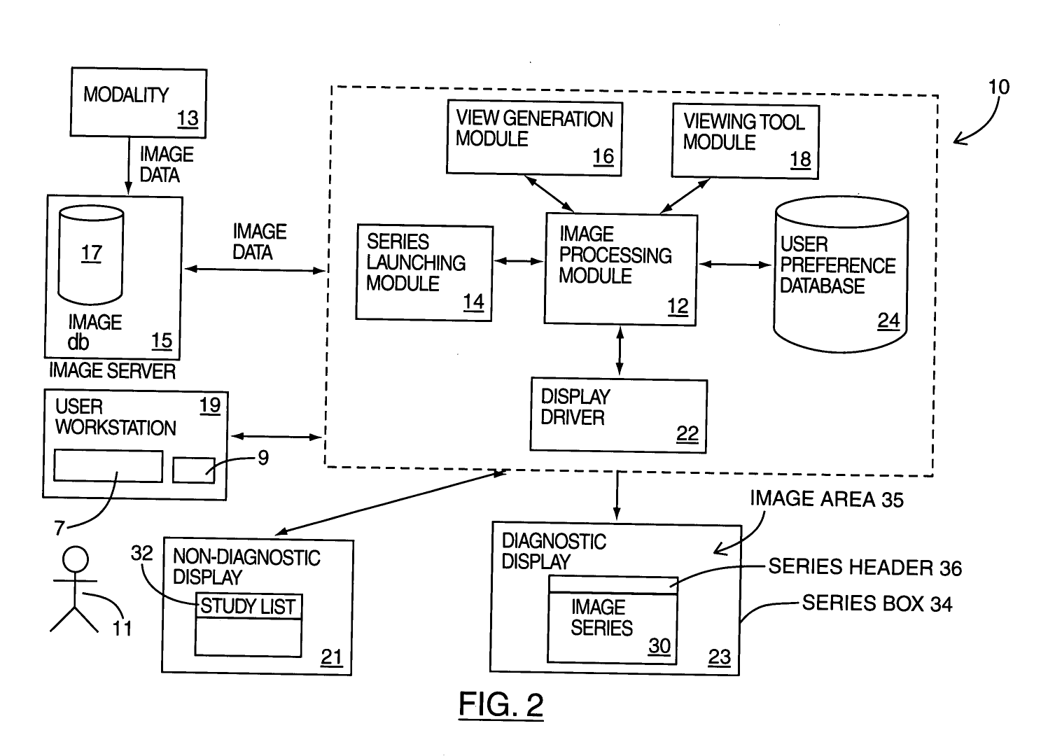

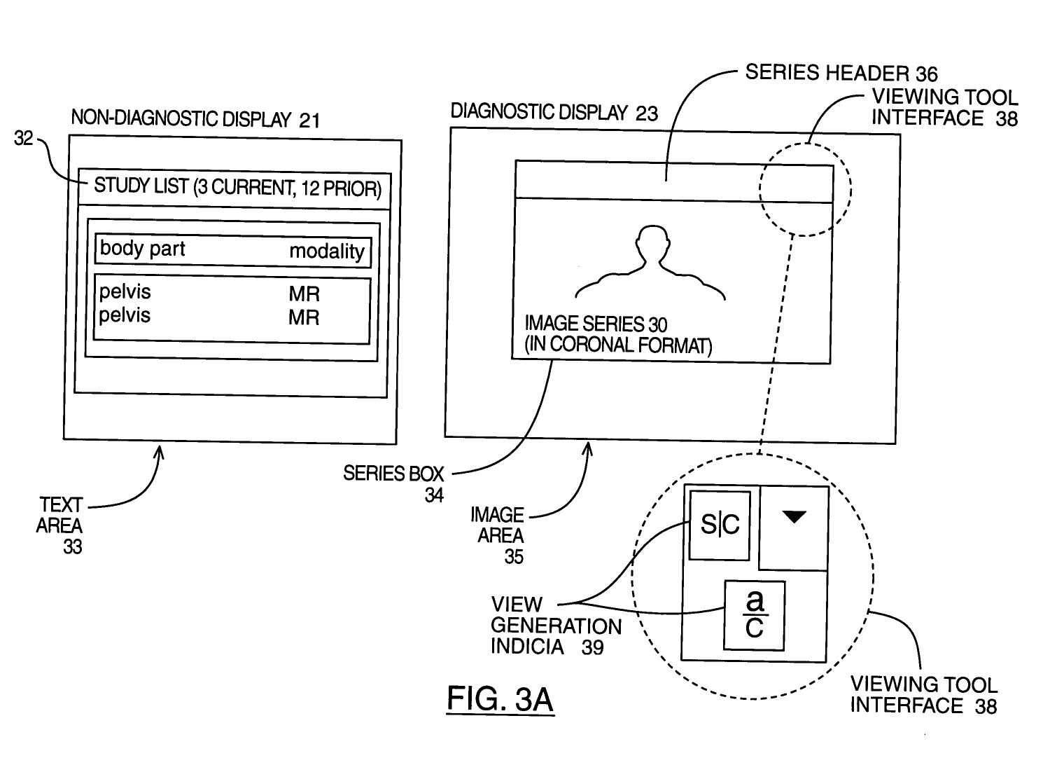

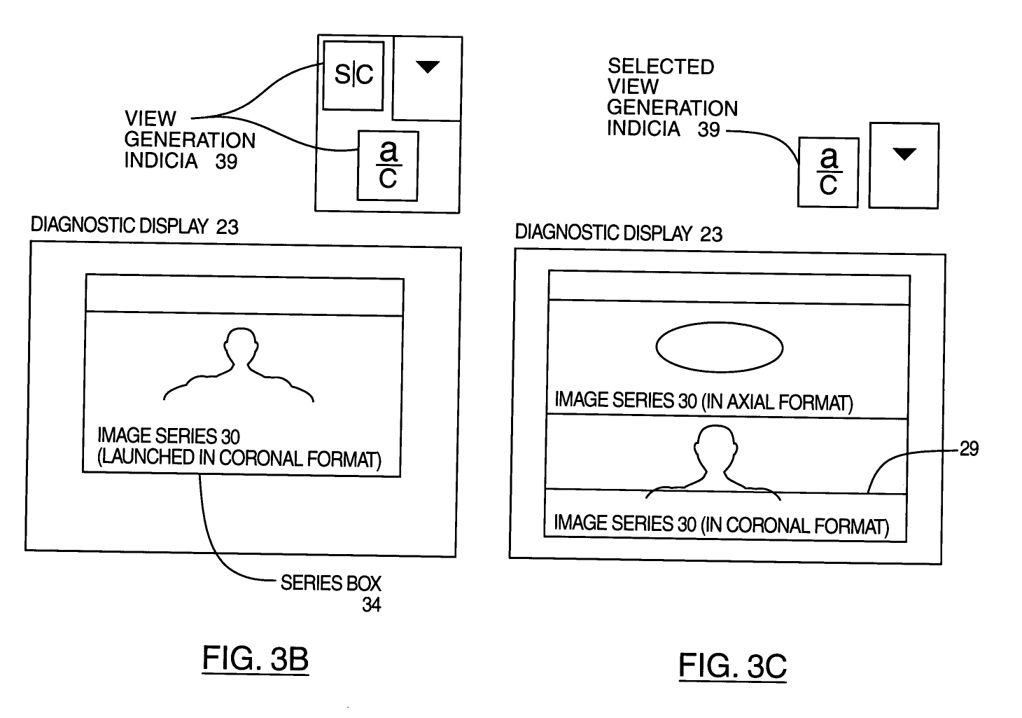

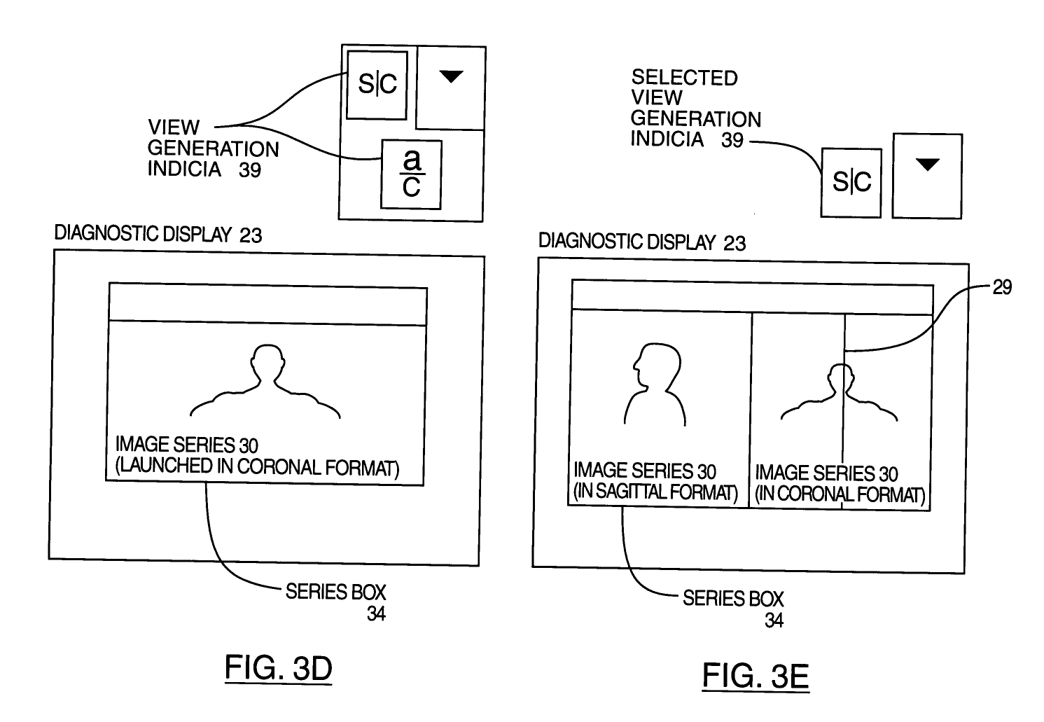

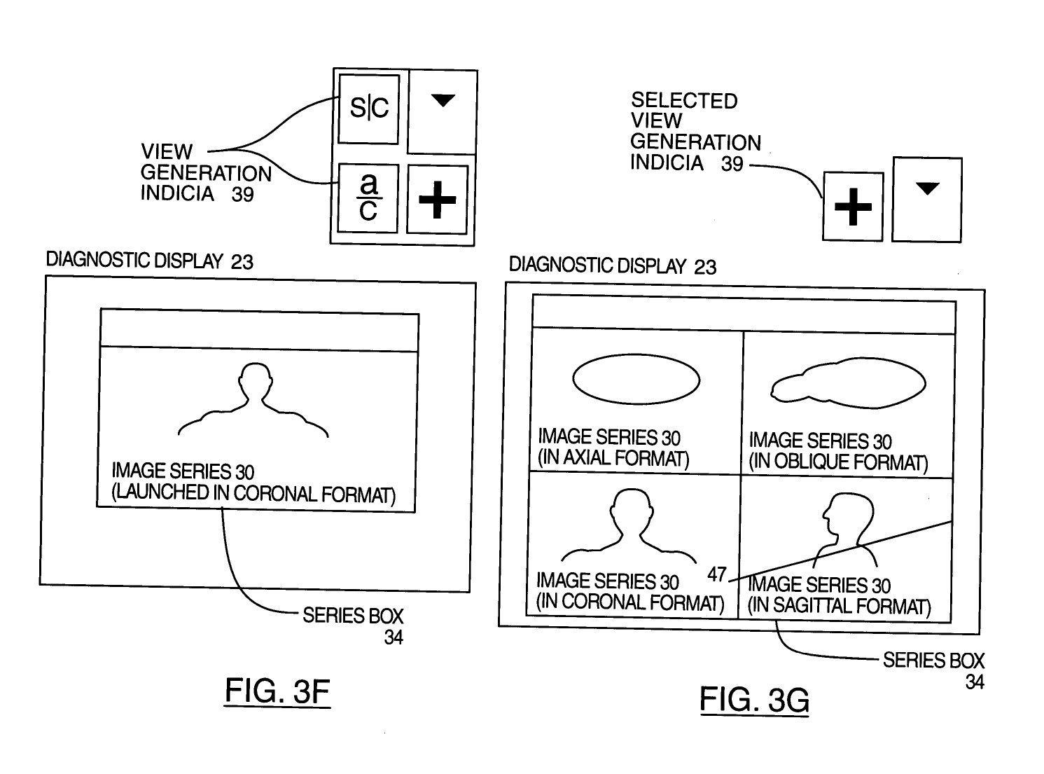

FIGS. 2 and 3A to 3G illustrate the multi-planar viewing system 10 built in accordance with the present invention. Specifically, multi-planar viewing system 10 includes an image processing module 12, a series launching module 14, a view generation module 16, a viewing tool module 18 and a display driver 22.

As shown, image data associated with an image series 30 (i.e. a series of medical exam images) is generated by a modality 13 and stored in an image database 17 on an image server 15 for retrieval and display on diagnostic display 23. User 11 selects or “launches” an image series 30 from study list 32 on non-diagnostic display 21 in a selected initial planar orientation (e.g. sagittal, coronal, or axial orthogonal views, or a selected oblique view) using series launching module 14 and view generation module 16. The image series 30 selected for viewing by user 11 will be referred to as the “launching series”. Series launching module 14 retrieves image data that corresponds to the image series 30 selected for viewing and provides it to view generation module 16.

View generation module 16 generates the image series 30 in an initial planar orientation (e.g. sagittal, coronal, or axial orthogonal views, or a selected oblique view) selected by the user 11 or through a default system as will be explained. The viewing tool module 18 then generates a viewing tool interface 38 (FIG. 3A) having a selection of view generation indicia 39 (FIG. 3A) that is based on the initial planar orientation of the launching series 30. Image processing module 12 then displays the launching series 30 in the initial planar orientation along with the dynamically generated viewing tool interface 38.

User 11 then selects one of the view generation indicia 39 to obtain a multi-planar display of image series 30. Each view generation indicia 39 represents what will be referred to as a “viewing format” for the image series 30. Specifically, the viewing format includes selected planar views and a screen arrangement for the selected planar views. In this way, multi-planar viewing system 10 provides user 11 with an improved diagnostic environment that is more intuitive and user friendly and allows the user 11 to quickly obtain orthogonal and oblique views of image series 30.

User workstation 19 includes a keyboard 7 and a user pointing device 9 (e.g. mouse) as shown in FIG. 2. It should be understood that user workstation 19 may be implemented by any wired or wireless personal computing device with input and display means (e.g. conventional personal computer, laptop computing device, personal digital assistant (PDA), wireless communication device, etc.) User workstation 19 is operatively connected to non-diagnostic display 21 and diagnostic display 23. Multi-planar viewing system 10 is preferably installed on the hard drive of user workstation 19 and on image server 15, such that user workstation 19 works with image server 15 in a client-server configuration.

Non-diagnostic display 21 displays a study list 32 within text area 33 to user 11. Study list 32 provides a textual format listing of image series 30 that are available for display. Study list 32 also includes associated identifying indicia (e.g. body part, modality, etc.) and organizes image series 30 in current and prior study categories. Other associated textual information (e.g. patient information, image resolution quality, date of image capture, etc.) is simultaneously displayed within study list 32 to further assist the user 11 in selection of image series 30. Typically, user 11 will review study list 32 and select a desired listed image series 30 for display on diagnostic display 23. Non-diagnostic display 21 is preferably implemented using a conventional color computer monitor (e.g. a color monitor with a resolution of 1024×768) with sufficient processing power to run a conventional operating system (e.g. Windows NT). High resolution graphics are not typically necessary for non-diagnostic display 21 since this display is usually only displaying textual information to user 11.

Diagnostic display 23 provides high resolution image display of image series 30 to user 11 within image area 35. Image series 30 is displayed within a series box 34 that is defined within image area 35. Series box 34 also contains a series header 36 that contains a viewing tool interface 38 (FIG. 3A). Viewing tool interface 38 includes dynamically view generation indicia 39 (FIG. 3A) that reflect the particular launching series 30 at issue as will be described in more detail. Diagnostic display 23 is preferably implemented using medical imaging quality display monitors with relatively high resolution typically used for viewing CT image studies (e.g. black and white “reading ” monitors with a resolution of 1280-1024 and up).

Display driver 22 is a conventional display screen driver implemented using commercially available hardware and software. As shown in FIG. 2, display driver 22 ensures that image series 30 are displayed in a proper format on diagnostic display 23. Specifically, image series 30 are displayed within series boxes 34 that are defined within image area 35. Each series box 34 contains an image series 30 as well as a series header 36. Display driver 22 provides image data associated with image series 30 appropriately formatted so that image series 30 are properly displayed within one or more series boxes 34.

Modality 13 is any conventional image data generating device (e.g. computed tomography (CT) scanners, etc.) utilized to generate image data that corresponds to patient medical exams. A medical practitioner utilizes the image data generated by modality 13 to make a medical diagnosis (e.g. for investigating the presence or absence of a diseased part or an injury or for ascertaining the characteristics of the diseased part or the injury). Modalities 13 may be positioned in a single location or facility, such as a medical facility, or may be remote from one another. Image data from modality 13 is stored within image database 17 within an image server 15 as conventionally known.

Image processing module 12 coordinates the activities of series launching module 14, view generation module 16 and viewing tool module 18 in response to commands sent by user 11 from user workstation 19 and stored user display preferences from user display preference database 25. When user 11 launches an image series 30 from study list 32 on non-diagnostic display 21, image processing module 12 instructs series launching module 14 to retrieve image data that corresponds to the selected image series (i.e. the “launching series”) and to provide it to view generation module 16. Since user 11 has also selected an initial planar orientation (e.g. sagittal, coronal, or axial orthogonal views, or oblique view), view generation module 16 generates the image series 30 in the initial planar orientation. Finally, image processing module 12 instructs viewing tool module 18 to dynamically generate a viewing tool interface 38 having certain view generation indicia 39 based on the initial planar orientation of the launching series.

Series launching module 14 is utilized by image processing module 12 to retrieve image data from image server 15 associated with the selected image series 30 for display on diagnostic display 23. The particular initial planar orientation for the launching series 30 is determined on the basis of user preference (explicit or preferred) or on the basis of default system preferences. When user 11 launches an image series 30 from study list 32 on non-diagnostic display 21, image processing module 12 instructs series launching module 14 to retrieve image data that corresponds to the launching series 30 and to provide it to view generation module 16.

Series launching module 14 allows user 11 to explicitly request a particular initial planar orientation (e.g. axial, coronal, sagittal or oblique) for an image series 30 from study list 32. User 11 may also establish a default initial planar orientation preference in the user preference database 24. Such viewing format preferences would be utilized in the case where no explicit selection of an initial planar orientation is made by user 11. For example, user 11 may establish a default initial planar orientation preference within user preference database 24 for all image series 30 to be initially displayed in a coronal initial planar orientation. In such a case, any image series 30 launched without an explicit initial planar orientation selection will be launched on diagnostic display 23 in a coronal planar view format (FIGS. 3B, 3D and 3F).

Series launching module 14 also provides for the ability to establish system-wide or multi-user (i.e. departmental) initial planar orientation defaults. These kinds of initial planar orientation defaults would preferably be applied when no explicit initial planar orientation is selected on launch and when no user default has been established. For example, a departmental viewing format default could be established by a CT specialty department in a hospital such that on start-up and in the absence of any user defaults or explicit user selections, an image series 30 is launched in coronal initial planar orientation (FIGS. 3B, 3D and 3F).

Also, should be understood that it is contemplated that series launching module 14 would monitor the initial planar orientation and viewing format selections a user 11 or a group of users 11 makes in previous imaging sessions and store related preferences in preference database 24. Accordingly, when an image series is launched, viewing format preferences established in a previous session would be utilized.

As discussed above, view generation module 16 receives image data that corresponds to the launching series 30 from series launching module 14. Since user 11 has also selected an initial planar orientation (e.g. sagittal, coronal, or axial orthogonal views, or oblique), view generation module 16 generates the image series 30 in this initial planar orientation for display within series box 34 on diagnostic display 23.

View generation module 16 also generates a scout line 29 within the image series 30. This scout line 29 is used to indicate the location and progress of image series 30 in one planar orientation in reference to image series 30 in another planar orientation. For example, as shown in FIG. 3C the scout line 29 within the image series 30 having a coronal planar orientation (located at the bottom of the series box 34) indicates the location and progress of the image series 30 having an axial planar orientation (located at the top of series box 34). Similarly, as shown in FIG. 3E, the scout line 29 within the image series 30 having a coronal planar orientation (located at the right of the series box 34) indicates the location and progress of the image series 30 having a sagittal planar orientation (located at the left of series box 34).

Viewing tool module 18 is utilized by image processing module 12 to dynamically generate a viewing tool interface 38 within series header 36 (FIG. 3A) based on the initial planar orientation of the launching series 30 as discussed above. The viewing tool interface 38 provides the user 11 with a selection of view generation indicia 39 that are dynamically generated based on the initial planar orientation of the launching series.

Preferably, two view generation indicia 39 are generated that include the initial planar orientation of launching series 30. The first view generation indicia 39 represents a first viewing format (e.g. view generation indicia sic 39 in FIG. 3B) for application to the image series 30 and the second view generation indicia 39 represents a second related viewing format (e.g. view generation indicia

$$\frac{a}{c} 39$$

in FIG. 3B) for application to the image series 30. Again, it should be understood that dynamic generation of the view generation indicia 39 can be based on the initial planar orientation of the launching series in a number of different ways.

For example, as illustrated in FIGS. 3B and 3D, if an image series 30 was launched in coronal initial planar orientation, then viewing tool module 18 generates a viewing tool interface 38 containing a s|c view generation indicia 39 and a a/c view generation indicia 39 (FIGS. 3B and 3D). Both s|c and a/c view generation indicia 39 contains initial planar orientation, namely the indicia “c” which represents “coronal”. Further, the s|c view generation indicia 39 also contains an indicia “s” that represents the related sagittal planar view and the a view generation indicia 39 also contains an indicia “a” that represents the related axial planar view. In this way, the user 11 is able to select a viewing format by selecting the desired view generation indicia 39 from the viewing tool interface 38. This allows the user 11 to compare the initial planar orientation (e.g. coronal) with either of the other related viewing formats (e.g. sagittal or axial, etc.)

Referring back to FIGS. 3C and 3E, multi-planar image viewing system 10 allows a user 11 to select a desired multi-planar display of image series 30. View generation module 16 preferably generates a multi-planar display of image series 30 using a split-screen technique whereby the launching series 30 is displayed within one portion of a split screen in the initial planar orientation and then displayed within the other portion of the split screen in another viewing format that is orthogonal or oblique to the initial planar orientation. The screen arrangement of the two portions within the split screen is also represented within the view generation indicia 38 (i.e. whether the planar views are positioned above and below or side to side etc.)

When user 11 selects a view generation indicia 39 from viewing tool interface 38, the image series 30 is displayed in the viewing format (i.e. the planar views and the screen arrangement) represented by the view generation indicia 39. For example, if the user 11 selects the a/c view generation indicia 39 of the viewing tool interface 38 (FIG. 3A), then axial and coronal planar views of the launching series 30 are displayed (FIG. 3C). Alternatively, if the user 11 selects the s|c view generation indicia 39 (FIG. 3A), then sagittal and coronal planar views of the launching series 30 are displayed (FIG. 3E).

As shown in FIGS. 3F and 3G, view generation indicia +39 is generated alongside the orthogonal view generation indicia 39 and allows the user 11 to select an oblique planar view. The view generation indicia +39 represents the oblique view of image series 30 and results in a viewing format generated by view generation module 16 (FIG. 3G) having quadrants being that contain all of the orthogonal views (i.e. axial, coronal and sagittal planar formats and an oblique view (i.e. oblique format) that the user 11 can manipulate and save.

Specifically, selection of the orientation of the oblique planar view is accomplished using conventionally known techniques. For example, an oblique navigation line 47 (FIG. 3G) is typically provided within one or more of the image series 30 within active series box 34 for the user 11 to manipulate. The user 11 can move the position of the oblique view by selecting the navigation handle (not shown) associated with the navigation line 47 and dragging the navigation handle up or down. Also, the user 11 can change the center position of the oblique view by selecting the translation handle (not shown) and dragging it along the oblique navigation line 47. Finally, the user 11 can change the angle of the oblique view by selecting a rotation handle (not shown) on the oblique navigation line 47 and dragging it up or down.

It should be understood that the determination of the view generation indicia 39 to be displayed can be based in different ways on the initial planar orientation of the launching series. That is, while it is preferred for view generation indicia 39 that include the initial planar orientation of the launching series 30 (e.g. where the s|c and a|c view generation indicia are generated based on a coronal formatted launching series), it should be should be understood that various other contextual-based relations can be used to generate the view generation indicia 39.

For example, viewing tool module 18 could utilize a rule whereby view generation indicia 39 are generated that correspond to viewing formats that do not include the initial planar orientation of the launching series 30. For example, if the initial planar orientation for the launching series 30 is coronal, then a|s and s|a view generation indicia 39 would be generated and so on.

Another example would be where viewing tool module 18 utilizes a rule whereby view generation indicia 39 are generated that contain indicia that correspond to all of the various positional arrangements of associated formats. To illustrate this example, if the viewing format for the launching series 30 is coronal, then s|c, c|s, a|c and c|a view generation indicia 39 would be generated and so on. It can be seen that many combinations of the various planar views and screen arrangements (i.e. either one above the other or side by side, which one is positioned above the other, etc.) are possible and that many associated view generation indicia 39 may be generated.

As will be discussed, the specific appearance and arrangement of view generation indicia 39 within viewing tool interface 38 can be accomplished in various ways. In the present example, the view generation indicia 39 are positioned in a way that illustrates how the various viewing formats (i.e. planar views and screen arrangement) will appear within series box 34. Accordingly, the view generation indicia a|c and c|a 39 will have different significances for the user 11 in terms of relative side by side position of the axial and coronal formats of image series 30.

While a few examples of how specifically the view generation indicia 39 can be generated have been provided, it should be understood that various methods of selecting view generation indicia 39 and various display conventions for the view generation indicia 39 can be observed within multi-planar viewing system 10.

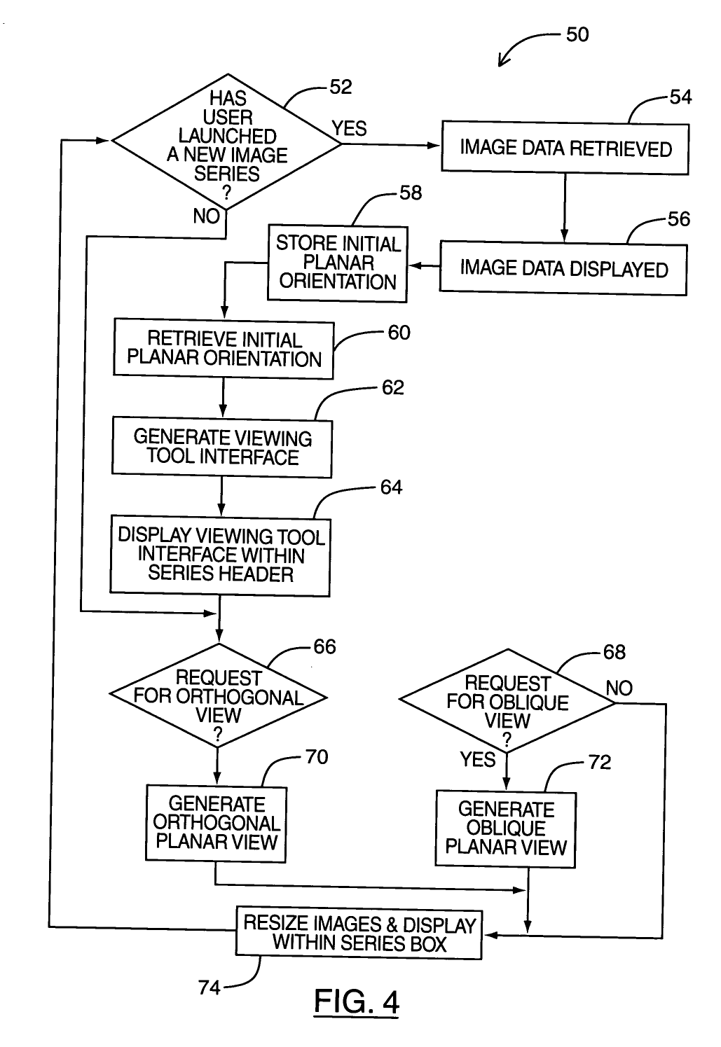

Referring now to FIGS. 2, 3A to 3G and 4 the basic operation of multi-planar viewing system 10 will be discussed. Specifically, FIG. 4 illustrates the basic operational steps 50 executed by multi-planar viewing system 10.

At step (52), it is determined whether user 11 is launching a new image series 30. If a new image series 30 is not being launched, then image processing module 12 checks to see whether the user is selecting a view generation indicia 39 at step (66) as will be discussed. If a new image series 30 is being launched, then image processing module 12 processes step (54).

If the user 11 has requested display of a new image series 30 then at step (54), image processing module 12 requests the image data associated with the requested new image series 30 from image server 15. Image server 15 identifies the requested image data and retrieves it from image database 17 and sends it to image processing module 12. At step (56), image series 30 is displayed in the initial planar orientation within image box 34 on diagnostic display 23 (e.g. image series 30 displayed in coronal format as shown in FIGS. 3B and 3D). At step (58), series launching module 14 stores the initial planar orientation (e.g. coronal format) within user preference database 24 for future reference.

At step (60), viewing tool module 18 retrieves the initial planar orientation of the launching series. At step (62), viewing tool module 18 generates a viewing tool interface 38 for display within series header 36. As discussed above, depending on the initial planar orientation of the launching series, certain view generation indicia 39 are provided within viewing tool interface 38. Preferably, two view generation indicia 39 are generated. Preferably, the first view generation indicia 39 represents a viewing format that includes the initial planar orientation of the launching series 30 and one related viewing format (FIG. 3A). Preferably, the second view generation indicia 39 represents a viewing format that includes the initial planar orientation of the launching series 30 and another related viewing format (FIG. 3A).

For example, in the case of a launching series 30 having an axial initial planar orientation, viewing tool module 18 will generate the view generation indicia s|a and

$$\frac{a}{c} 39.$$

If the launching image series 30 is in coronal format, viewing tool module 18 will generate the view generation indicia s|c and

$$\frac{a}{c} 39$$

(FIG. 3B). Finally, if the launching image series 30 is in sagittal format, viewing tool module 18 will generate the view generation indicia s|c and

$$\frac{s}{a} 39.$$

As discussed above, it should be understood that in all cases viewing tool interface 38 displays view generation indicia +39 to provide the user 11 with the option of selecting an oblique planar view. Also, it should be understood that dynamic generation of view generation indicia 39 can be based on the initial planar orientation of the launching series in a number of different ways.

At step (64), viewing tool module 18 displays a viewing tool interface 38 within series header 36 within diagnostic display 23. Viewing tool interface 38 includes the various view generation indicia 39 generated by viewing tool module 18. As discussed above, viewing tool interface 38 always includes the view generation indicia +39 to provide the user 11 with the option of selecting oblique views of image series 30.

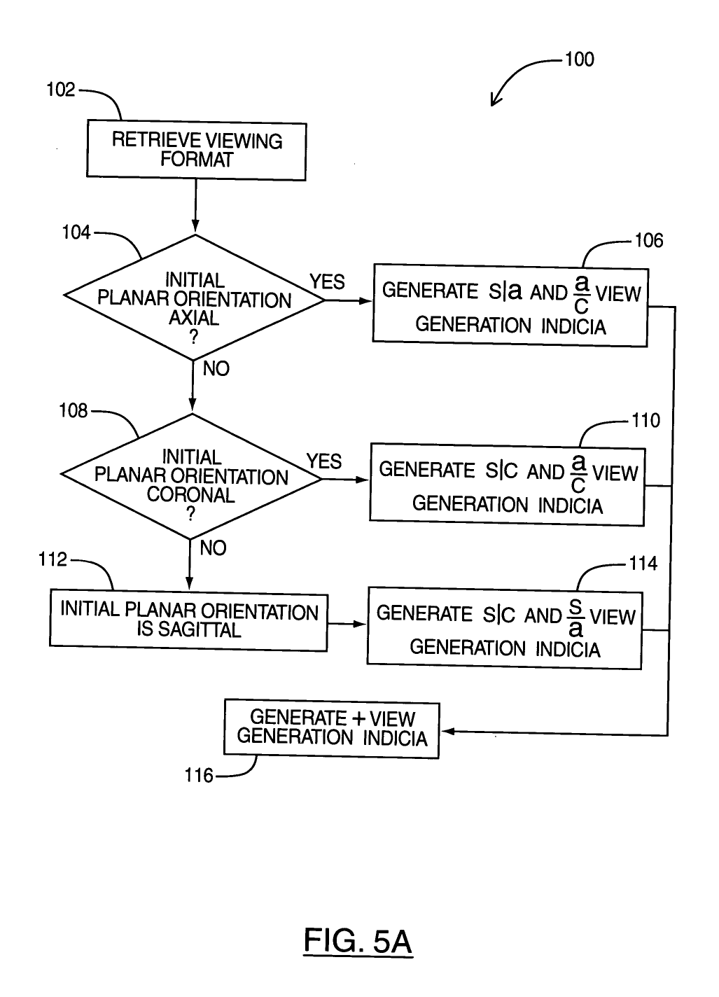

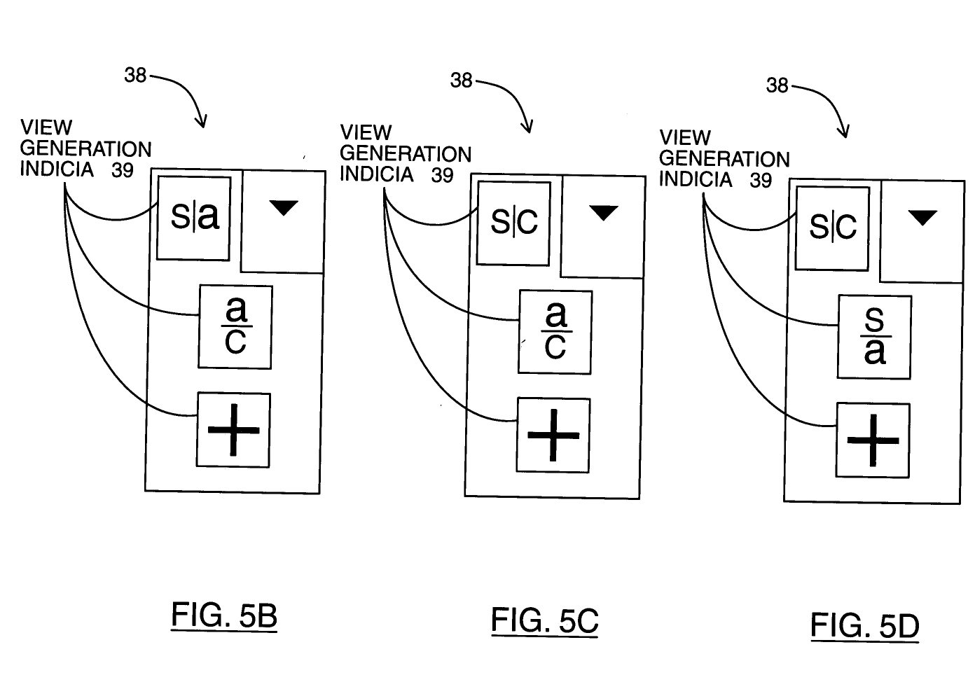

At step (66), image processing module 12 polls view generation indicia 39 to determine whether user 11 has requested an orthogonal planar view combination (e.g. view generation indicia s|a 39) from the displayed view generation indicia 39. If so, then at step (70), view generation module 16 will generate the selected orthogonal planar views as will be described in more detail in reference to FIG. 5A.

At step (68), image processing module 12 polls view generation indicia 39 to determine whether user 11 has requested an oblique view combination (i.e. view generation indicia +39). If so, then at step (72), view generation module 16 generates the selected oblique view as will be described in more detail in reference to FIG. 5B.

Finally, at step (76), the selected orthogonal or oblique views of image series 30 are resized and displayed within series box 34. Specifically, image processing module 12 obtains the orthogonal and/or oblique views of image series 30 selected by user 11 from view generation module 16 and determines the optimal way to display them within series box 34 and instructs display driver 22 accordingly. The considerations that go into this determination can include the number of image series boxes 34 currently being displayed on diagnostic display 23, the resolution of the image series 30 being viewed and the resolution of the diagnostic display 23 itself (e.g. the resolution of the monitor).

FIGS. 5A to 5D illustrate one example way that viewing tool module 18 can generate the viewing tool interface 38 based on the initial planar orientation of the launching series 30. Specifically, FIG. 5A is a flowchart showing the process steps 100 utilized by viewing tool module 18 to generate the viewing tool interface 38 and FIGS. 5B to 5D are schematic diagrams showing the various viewing tool interfaces 38 displayed on diagnostic display 23 as viewing tool module 18 performs these steps.

At step (102), image processing module 12 retrieves the viewing format for the launching series 30 from user preference database 24. Depending on the particular viewing format, viewing tool module 18 will generate a certain arrangement of view generation indicia 39. The specific determination illustrated in FIGS. 5A to 5D is made based on the assumption that if the user 11 has chosen to launch an image series 30 in a particular initial planar orientation (e.g. axial) then the user 11 will want to have the option of comparing the image series 30 in that particular planar orientation to the two other related orthogonal planar orientations.

Accordingly, at step (104), it is determined whether the initial planar orientation is axial. If so, then at step (106), it is determined that the user 11 will want to have the option of comparing an axial planar view of the image series 30 to the two other related planar views. Specifically, viewing tool module 18 generates the view generation indicia s|a and

$$\frac{a}{c} 39$$

(FIG. 5B).

At step (108), it is determined whether the initial planar orientation is coronal. If so, then at step (110), it is determined that the user 11 will want to have the option of comparing a coronal planar view of the image series 30 to the two other related planar views. Specifically, viewing tool module 18 generates the view generation indicia s|c and

$$\frac{a}{c} 39$$

(FIG. 5C).

Finally, at step (112), it is determined whether the initial planar orientation is sagittal. If so, then at step (114) it is determined that the user 11 will want to have the option of comparing a sagittal planar view of the image series 30 to the two other related planar views. Specifically, viewing tool module 18 generates the view generation indicia s|c and

$$\frac{s}{a} 39$$

(FIG. 5D).

Once the view generation indicia 39 representing the two other related planar views have been generated, at step (116), viewing tool module 18 generates the oblique view generation indicia +39 for display within viewing tool interface 38. It should be noted that the oblique view generation indicia +39 is provided within all of the generated viewing tool interfaces 38. This ensures that the user 11 always has the option of selecting the generation of an oblique view of image series 30 as will be described.

It should be understood that the specific arrangement of view generation indicia 39 within viewing tool interface 38 can be implemented in various ways. In the present example, the view generation indicia 39 are positioned in a way that illustrates how the generated views will be positioned within series box 34. That is, the view generation indicia s|a within viewing tool interface 38 (FIG. 5B) indicates that when the sagittal and axial planar views of the image series 30 are displayed they will be positioned within series box 34 in a horizontal manner with the sagittal planar view on the left and the axial planar view on the right. However, the view generation indicia s/a 39 within viewing tool interface 38 (FIG. 5D) indicates that when the sagittal and axial planar views of the image series 30 are displayed they will be positioned within series box 34 in a vertical manner with the sagittal planar view on the top and the axial planar view on the bottom. However, it should be understood that various display conventions could be observed.

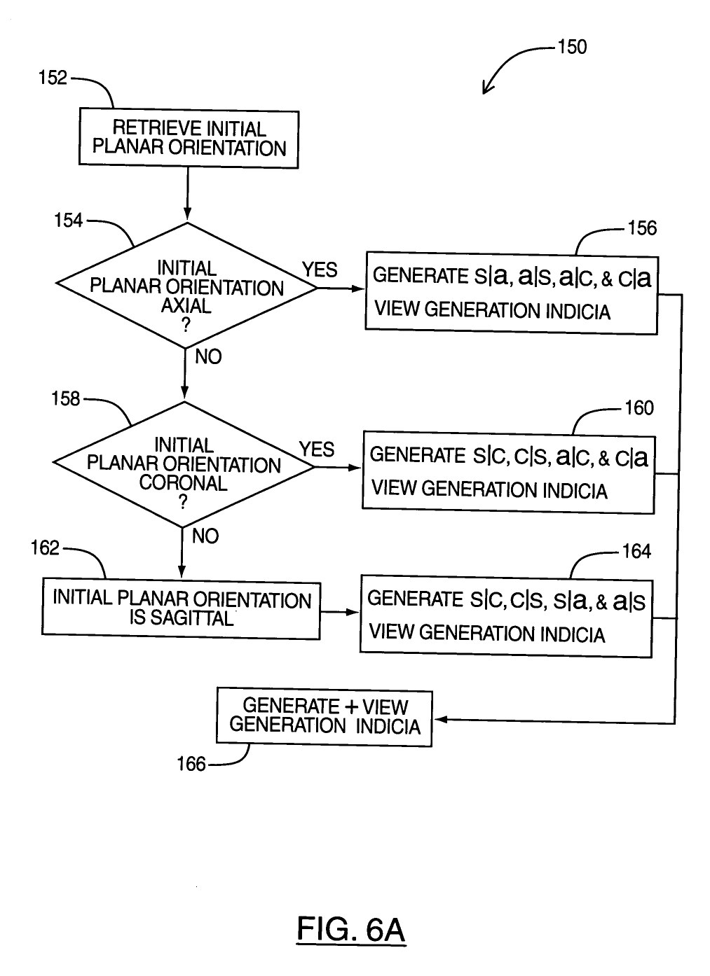

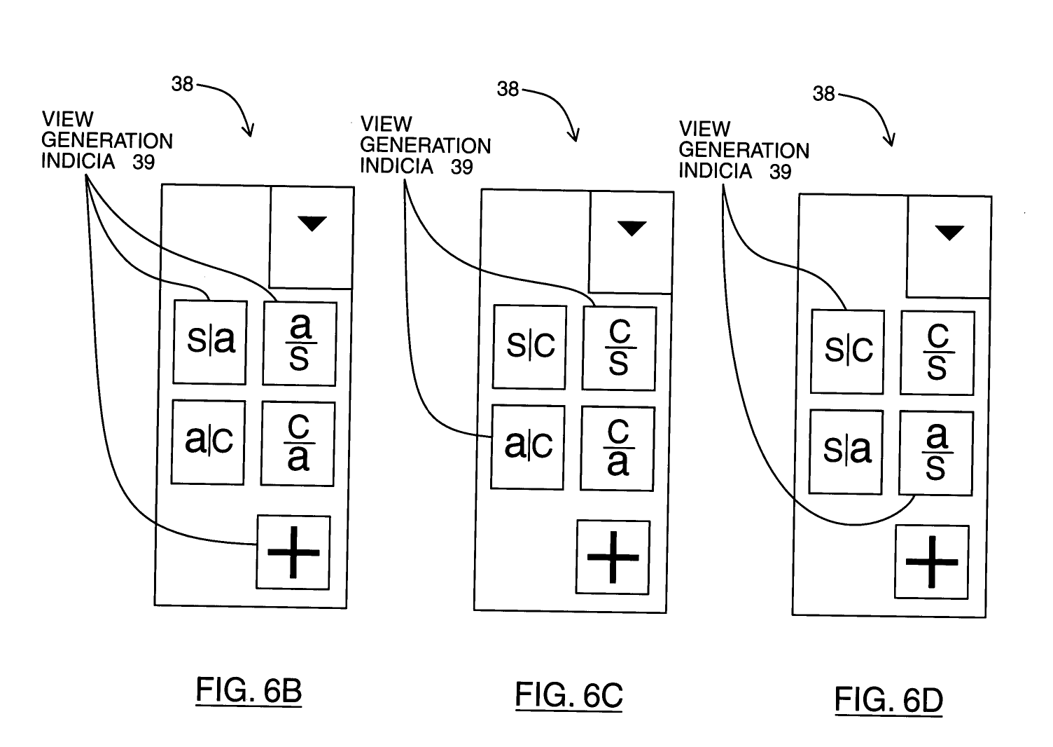

FIGS. 6A to 6D illustrate another example way that viewing tool module 18 could be used to generate the viewing tool interface 38 based on the initial planar orientation of the launching series 30. Specifically, FIG. 6A is a flowchart showing the process steps 150 utilized by viewing tool module 18 to generate the viewing tool interface 38 and FIGS. 6B to 6D are schematic diagrams showing the various viewing tool interfaces 38 displayed on diagnostic display 23 as viewing tool module 18 performs these steps.

At step (152), image processing module 12 retrieves the initial planar orientation for the launching series 30 from user preference database 24. Depending on the particular initial planar orientation, viewing tool module 18 will generate a certain arrangement of view generation indicia 39. The example determination illustrated in FIGS. 6A to 6D is made based on the assumption that if the user 11 has chosen to launch an image series 30 in a particular initial planar orientation (e.g. axial) then the user 11 will want to have the option of comparing the image series 30 in that particular planar orientation to the two other related planar orientations in two different screen arrangements (i.e. relative positions) as will be illustrated.

At step (152), image processing module 12 retrieves the initial planar orientation for the launching series 30 from user preference database 24.

At step (154), it is determined whether the initial planar orientation is axial. If so, then at step (156), viewing tool module 18 generates the view generation indicia s|a, a|s, a|c and c|a 39 (FIG. 6B).

At step (158), it is determined whether the initial planar orientation is coronal. If so, then at step (160), viewing tool module 18 generates the view generation indicia s|c, c|s, a|c and c|a.

At step (162), it is determined whether the initial planar orientation is sagittal. If so, then at step (164), viewing tool module 18 generates the view generation indicia s|c, c|s, s|a and a|s 39 (FIG. 5D).

At step (166), viewing tool module 18 generates the oblique view generation indicia +39 for display within viewing tool interface 38. It should be noted that for all the viewing tool interfaces 38, the oblique view generation indicia +39 is provided allowing user 11 the option of selecting the generation of an oblique view of image series 30.

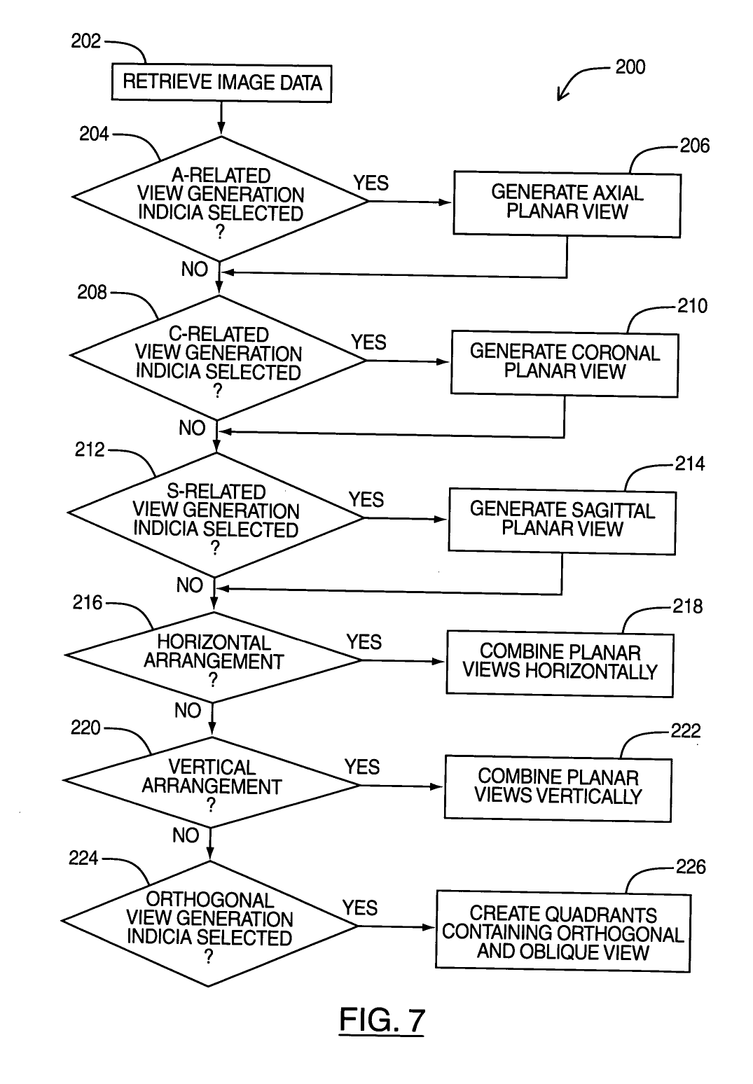

FIG. 7 is a flowchart showing the process steps 200 utilized by view generation module 16 to generate various viewing formats for image series 30 that consist of various combinations of orthogonal and oblique planar views of image series 30 in various screen arrangements (i.e. relative positions).

Once the viewing format (i.e. the desired specific planar views and screen arrangement) has been selected by user 11 for application to image series 30at step (202), view generation module 16 retrieves the image data associated with the launching series 30 from image database 17 on image server 15.

At step (204), view generation module 16 determines whether an axial related view generation indicia 39 (i.e. one that includes an indicia that corresponds to the axial planar view) has been selected. If so, then at step (206), view generation module 16 generates the axial planar view for image series 30.

At step (208), view generation module 16 determines whether a coronal related view generation indicia 39 (i.e. one that includes an indicia that corresponds to the coronal planar view) has been selected. If so, then at step (210), view generation module 16 generates the coronal planar view for image series 30.

At step (212), view generation module 16 determines whether a sagittal related view generation indicia 39 (i.e. one that includes an indicia that corresponds to the sagittal planar view) has been selected. If so, then at step (214), view generation module 16 generates the sagittal planar view for image series 30.

At step (216), view generation module 16 determines whether the selected view generation indicia 39 corresponds to a screen arrangement that entails horizontal placement of the respective planar views. If so, then at step (218), the planar views obtained from steps (206), (210), and/or (214) are combined in a horizontal manner within series box 34.

At step (220), view generation module 16 determines whether the selected view generation indicia 39 corresponds to vertical placement of the respective planar views. If so, then at step (222), the planar views obtained from steps (206), (210), and/or (214) are combined in a vertical manner within series box 34.

At step (224), view generation module 16 determines whether the oblique view generation indicia +39 has been selected. If so then at step (226), quadrants are created containing the various orthogonal planar views as well as an oblique planar view of image series 30 (FIG. 3G). As discussed before, the user 11 is presented with the ability to manipulate the oblique view and the user 11 can save the oblique view as a new view within image database 17.

Multi-planar viewing system 10 provides a user 11 with the ability to conveniently select from a number of particular viewing formats that are based on the initial planar orientation of a launching series 30. The viewing format includes selected planar views and a screen arrangement for the selected planar views. In this way, multi-planar viewing system 10 allows the user 11 to quickly obtain orthogonal and oblique views of image series 30.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A multi-planar image viewing system for displaying first and second selectable indicia on a display for application to a launching series having an initial planar orientation, said system comprising:
(a) a memory for storing the launching series and the initial planar orientation associated with the launching series;
(b) a processor coupled to the memory for:
(I) determining a first viewing format and a second viewing format for the launching series based on the initial planar orientation of the launching series; and
(II) displaying the first selectable indicia that corresponds to the first viewing format and the second selectable indicia that corresponds to the second viewing format on the display.

2. The multi-planar image viewing system of claim 1, wherein said processor generates and displays the launching series in the initial planar orientation and the first and second selectable indicia on the display.

3. The multi-planar image viewing system of claim 2, wherein said processor also generates and displays the launching series in the first viewing format on the display if the first selectable indicia is selected and generates and displays the launching series in the second viewing format on the display if the second selectable indicia is selected.

4. The multi-planar image viewing system of claim 3, wherein each of the first and second viewing formats include at least two planar views.

5. The multi-planar image viewing system of claim 1, wherein each of the first and second viewing formats include at least two planar views and a screen arrangement for the at least two planar views.

6. The multi-planar image viewing system of claim 5, wherein the screen arrangement is horizontal relative placement of the planar views.

7. The multi-planar image viewing system of claim 5, wherein the screen arrangement is vertical relative placement of the planar views.

8. The multi-planar image viewing system of claim 1, wherein the planar views associated with the first and second viewing formats include the initial planar orientation.

9. The multi-planar image viewing system of claim 1, wherein the planar views associated with the first and second viewing formats do not include the initial planar orientation.

10. The multi-planar image viewing system of claim 1, wherein at least one of said first and second viewing formats is an oblique planar view.

11. The multi-planar image viewing system of claim 1, wherein the initial planar orientation is predetermined prior to launch of the launching series.

12. The multi-planar image viewing system of claim 1, wherein said processor selects the initial planar orientation prior to launch of the launching series.

13. The multi-planar image viewing system of claim 1, wherein said processor also:
(A) determines a third viewing format and a fourth viewing format for the launching series based on the initial planar orientation of the launching series; and
(B) generates and displays the launching series in the first viewing format if the first selectable indicia is selected, generates and displays the launching series in the second viewing format if the second selectable indicia is selected, generates and displays the launching series in the third viewing format if the third selectable indicia is selected, and generates and displays the launching series in the fourth viewing format if the fourth selectable indicia is selected.

14. The multi-planar image viewing system of claim 1, wherein the initial planar orientation is selected from the group consisting of: sagittal, coronal, axial, and oblique.

15. A method for displaying first and second selectable indicia on a display for application to a launching series having an initial planar orientation, said method comprising:
(a) storing the launching series and the initial planar orientation associated with the launching series;
(b) determining a first viewing format and a second viewing format for the launching series based on the initial planar orientation of the launching series; and
(c) displaying the first selectable indicia that corresponds to the first viewing format and the second selectable indicia that corresponds to the second viewing format on the display.

16. The method of claim 15, further comprising generating and displaying the launching series in the initial planar orientation and the first and second selectable indicia on the display.

17. The method of claim 16, further comprising generating and displaying the launching series in the first viewing format on the display if the first selectable indicia is selected and generating and displaying the launching series in the second viewing format on the display if the second selectable indicia is selected.

18. The method of claim 17, wherein each of the first and second viewing formats include at least two planar views.

19. The method of claim 15, wherein each of the first and second viewing formats include at least two planar views and a screen arrangement for the at least two planar views.

20. The method of claim 19, wherein the screen arrangement is horizontal relative placement of the planar views.

21. The method of claim 19, wherein the screen arrangement is vertical relative placement of the planar views.

22. The method of claim 15, wherein the planar views associated with the first and second viewing formats include the initial planar orientation.

23. The method of claim 15, wherein the planar views associated with the first and second viewing formats do not include the initial planar orientation.

24. The method of claim 15, wherein at least one of said first and second viewing formats is an oblique planar view.

25. The method of claim 15, wherein the initial planar orientation is predetermined prior to launch of the launching series.

26. The method of claim 15, wherein the initial planar orientation is selected prior to launch of the launching series.

27. The method of claim 15, further comprising:
(A) determining a third viewing format and a fourth viewing format for the launching series based on the initial planar orientation of the launching series; and
(B) generating and displaying the launching series in the first viewing format if the first selectable indicia is selected, generating and displaying the launching series in the second viewing format if the second selectable indicia is selected, generating and displaying the launching series in the third viewing format if the third selectable indicia is selected, and generating and displaying the launching series in the fourth viewing format if the fourth selectable indicia is selected.

28. The method of claim 15, wherein the initial planar orientation is selected from the group consisting of: sagittal, coronal, axial, and oblique.
